(19) United States
(12) Patent Application Publication
(10) Pub. No.: US 2026/0161221 A1
(43) Pub. Date: Jun. 11, 2026

(54) CONTROL FRAMEWORK FOR EXTENDED REALITY (XR) DEVICES WITH DISCRETE PROCESSOR CHIPS

(71) Applicant: QUALCOMM Incorporated, San Diego, CA (US)

(72) Inventors: Utkarsh VINAYAK, Patna (IN); Venkatesh RAVIPATI, Guntur (IN); Nirav Narendra DESAI, Hyderabad (IN); Shriharsha CHEBBI, Hyderabad (IN); Karthik RANGARAJU, San Diego, CA (US); Shruti HANUMANTHAIAH, Bangalore (IN); Giridhar KAPALLI, San Diego, CA (US)

(21) Appl. No.: 18/969,987

(22) Filed: Dec. 5, 2024

(51) Int. Cl. G06F 3/01; G06F 21/31

(52) U.S. Cl. CPC G06F 3/013; G06F 21/31

(57) ABSTRACT

Aspects of the disclosure are directed to extended reality (XR) device control framework execution. In accordance with one aspect, the disclosure includes enabling a processor coupled to a non-transitory memory configured to store data to enable transitioning from one state to another state, wherein the processor performs the following steps in the order prescribed: (a) transitioning an extended reality (XR) device to a user detection state from a wireless discovery state; (b) transitioning the XR device to a user authentication state from the user detection state; and (c) transitioning the XR device to a monitoring state from the user authentication state.

This disclosure relates generally to the field of information processing systems, and, in particular, to a control framework for an extended reality (XR) device with discrete processor chips.

### BACKGROUND

Information processing systems for an augmented reality (AR) or extended reality (XR) device may utilize a plurality of processing engines, processors or processing cores for a variety of user applications. The plurality of processing engines may be implemented as a plurality of systems on a chip (SOC). The plurality of processing engines requires coordination for a seamless user experience. The coordination may be provided by a control framework to define power states, control paths, error handling and security.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides extended reality (XR) device control framework execution. Accordingly, the present disclosure discloses an apparatus including: a non-transitory memory configured to store data to enable transitioning from one state to another state; a central processor coupled to the non-transitory memory, the central processor configured to perform the following steps in the order prescribed: (a) transitioning an extended reality (XR) device to a user detection state from a wireless discovery state; (b) transitioning the XR device to a user authentication state from the user detection state; (c) transitioning the XR device to a monitoring state from the user authentication state; and a communication processor coupled to the non-transitory memory, the communication processor configured to detect a user presence.

In one example, the apparatus further includes a plurality of sensors coupled to the communication processor, wherein the communication processor uses the plurality of sensors configured to detect the user presence. In one example, the plurality of sensors includes at least one of the following: a proximity sensor, an inertial measurement unit (IMU), or an eye tracking sensor. In one example, the plurality of sensors is further configured to detect the user presence if a user is wearing the extended reality (XR) device. In one example, the plurality of sensors is further configured to detect the user presence if a user is wearing an extended reality (XR) device.

In one example, the central processor is further configured to transition the XR device to an active state from the monitoring state. In one example, the communication processor is further configured to: a) receive one or more data frames from a wireless companion; and b) decode the one or more data frames. In one example, the central processor is further configured to transition the XR device to the user detection state after establishing a wireless connection with a wireless companion. In one example, the wireless connection employs either a Bluetooth link or a WiFi link. In one example, if an authentication failure is detected in the active state, the central processor is then further configured to transition the XR device to the user authentication state.

Another aspect of the disclosure provides a method including: enabling a processor coupled to a non-transitory memory configured to store data to enable transitioning from one state to another state, wherein the processor performs the following steps in the order prescribed: (a) transitioning an extended reality (XR) device to a user detection state from a wireless discovery state; (b) transitioning the XR device to a user authentication state from the user detection state; and (c) transitioning the XR device to a monitoring state from the user authentication state.

In one example, the method further includes configuring the processor to transition the XR device to an active state from the monitoring state. In one example, the method further includes configuring the processor to transition the XR device to the wireless discovery state from a hinge close state. In one example, the method further includes configuring the processor to transition the XR device to the wireless discovery state upon detection of an open hinge. In one example, the method further includes configuring the processor to transition the XR device to the hinge close state. In one example, the method further includes commencing an XR device operation in a power off state. In one example, the method further includes configuring the processor to transition the XR device to an idle state from the active state.

Another aspect of the disclosure provides an apparatus including: means for transitioning an extended reality (XR) device to a user detection state from a wireless discovery state; means for transitioning the XR device to a user authentication state from the user detection state; and means for transitioning the XR device to a monitoring state from the user authentication state.

In one example, the apparatus further includes means for transitioning the XR device to an active state from the monitoring state; and means for transitioning the XR device to the wireless discovery state from a hinge close state. In one example, the apparatus further includes means for transitioning the XR device to an active state from the monitoring state; and means for transitioning the XR device to the hinge close state.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example extended reality (XR) device with multiple systems on a chip (SoCs).

FIG. 3 illustrates an example control framework state transition diagram for an extended reality (XR) system.

FIG. 4 illustrates an example power off state diagram for an extended reality (XR) system.

FIG. 5 illustrates an example hinge close state diagram for an extended reality (XR) system.

FIG. 6 illustrates an example wireless discovery state diagram for an extended reality (XR) system.

FIG. 7 illustrates an example user detection state diagram for an extended reality (XR) system.

FIG. 8 illustrates an example user authentication state diagram for an extended reality (XR) system.

FIG. 9 illustrates an example monitoring state diagram for an extended reality (XR) system.

FIG. 10 illustrates an example active state diagram for an extended reality (XR) system.

FIG. 11 illustrates an example idle state diagram for an extended reality (XR) system.

FIG. 12 illustrates an example flow diagram for an extended reality (XR) device control framework execution.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), may require multiple levels of coordination or synchronization. In one example, a slice may include a processing engine (i.e., a subset of the computing system) as well as associated memory units and other peripheral devices. In one example, execution of an application may be decomposed into a plurality of work tasks which are executed by multiple slices or multiple processing engines.

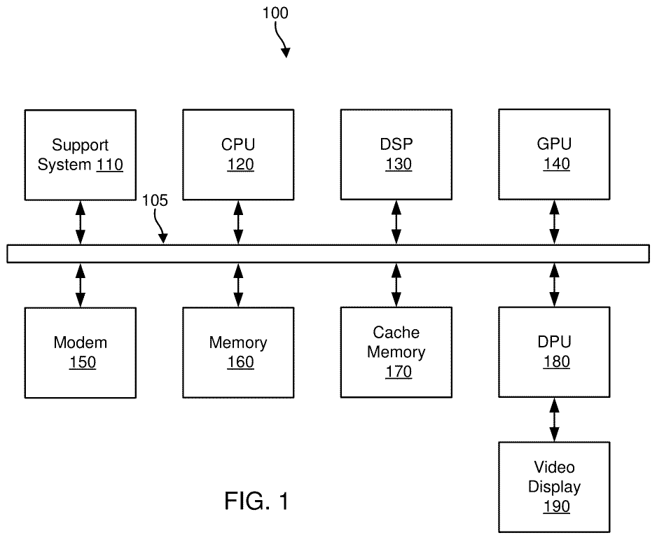

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information.

For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may connect to a plurality of peripheral devices to provide additional functionality. The plurality of peripheral devices may include, for example, cameras, imagers, sensors, displays, speakers, microphones, etc. In one example, processor-peripheral device communications may be implemented by a bidirectional high-speed interface.

In one example, the information processing system 100 may be part of a wireless device in a wireless communication system. For example, the wireless communication system may conform to a wireless network protocol such as 4G LTE (long term evolution), 5G NR (new radio, etc. In one example, an extended reality (XR) device is a device which provides an immersive sensory experience to a human user. In one example, the XR device may be an augmented reality (AR) device or a virtual reality (VR) device.

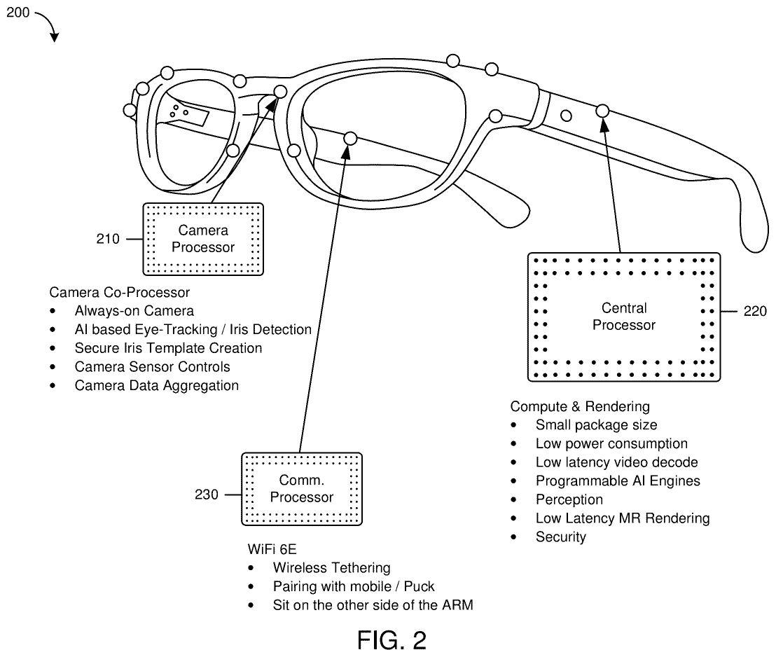

FIG. 2 illustrates an example extended reality (XR) device 200 with multiple systems on a chip (SoCs). In one example, the XR device 200 is XR eyeglasses. In one example, the example XR device 200 includes a camera processor 210, a central processor 220 and a communications processor 230. For example, the camera processor 210 may operate as an image processor. For example, the camera processor 210 provides for an always-on camera, provides eye tracking and iris detection using artificial intelligence (AI), creates a secure iris template, controls a camera sensor and aggregates camera data. For example, the central processor 220 may be housed in a small package with low dc power consumption and provides low latency video decoding, a programmable AI engine, perception, low latency mixed reality (MR) rendering and security. For example, the communications processor 230 provides a wireless modem (e.g., WiFi modem), wireless tethering, mobile pairing and connectivity with the central processor 220.

In one example, the example XR device 200 includes a plurality of processing engines or SOCs. For example, the plurality of processing engines requires continual coordination for a seamless user experience. In one example, a workload (i.e., a plurality of operational tasks) is distributed among different processing engines depending on a use case. For example, the workload distribution is needed to maintain a stringent thermal and power budget.

In one example, a coordinated power state entry for an individual SOC is necessary for maintenance of an optimal power and extension of battery life. For example, in a use case which utilizes the camera processor 210, central processor 220 and communications processor 230, entry into a different power state requires coordination. In one example, such coordination may be attained by using a control framework. In one example, the control framework defines a plurality of power states, a control path, error handling at different stages with enhanced security. For example, the control framework may be hosted by one or more processing engines, e.g., the central processor 220. For example, the control framework may be centralized in one processing engine or distributed among a plurality of processing engines. In one example, the control framework may be implemented in firmware (i.e., low level control algorithms).

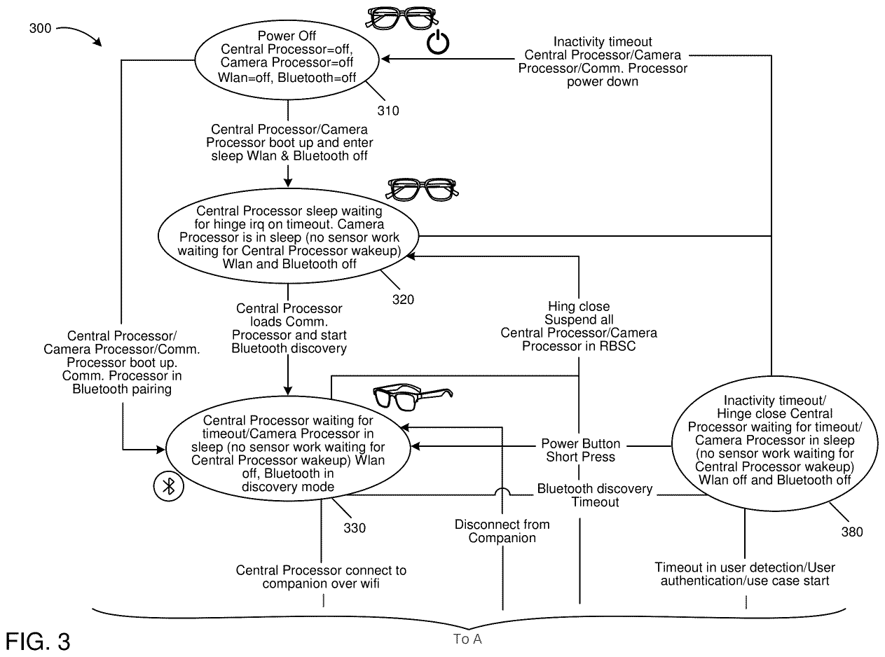

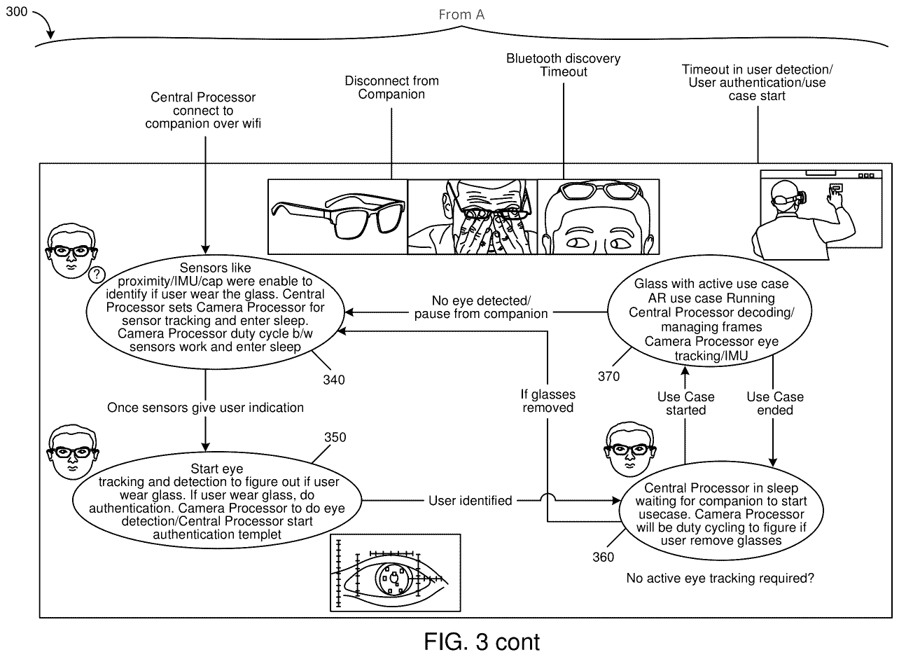

FIG. 3 illustrates an example control framework state transition diagram 300 for an extended reality (XR) system. In a first state 310, the control framework is placed in a power off state. In one example, the camera processor 210, the central processor 220 and the communications processor 230 (shown in FIG. 2) are all in the off state. For example, with the communications processor 230 in the off state, a wireless local area network (WLAN) and a short-range wireless network (e.g., Bluetooth) are both inactive.

In a second state 320, the camera processor 210 and central processor 220 are placed in a hinge close state and are booted up and transitioned into a sleep state. In a third state 330, the short-range wireless network is placed in a wireless discovery state. In a fourth state 340, a plurality of sensors is enabled and the camera processor 210 is placed into a user detection state. In one example, the plurality of sensors includes a proximity sensor, an inertial measurement unit (IMU), eye tracking sensor, etc. and is used to detect if a user is wearing an XR device (e.g., XR eyeglasses).

In a fifth state 350, the central processor 220 initiates a user authentication state. In a sixth state 360, the central processor 220 enters a monitor state and waits for a user to start a use case while in the monitor state. In one example, the camera processor 210 monitors if the user is removing the XR device. In a seventh state 370, the central processor 220 transitions to an active state upon detection of start of the use case by the user. In one example, the active state includes decoding and managing data frames.

In an eighth state 380, the central processor 220 and camera processor transition to an idle state. In one example, the idle state is commenced upon detection of an expiration time or upon detection of a hinge close on the XR device. In one example, the camera processor 210 and central processor 220 are transitioned into a sleep state.

In one example, the user detection state, the user authentication state and the monitor state may use the plurality of sensors in an increasing order of capability (e.g., proximity sensor first and eye tracking sensor last). In one example, the user authentication state may be based on eye iris detection. In one example, the user detection state, the user authentication state and the monitor state may be aggregated into a macro state. In one example, the user detection state employs the plurality of sensors to detect a user. In one example, the user authentication state may be optional depending on user preference and product security issues. In one example, user monitoring may be performed on a periodic basis to detect a user presence or a user absence.

In one example, state transitions in the control framework may be based on XR eyeglasses hinge position (i.e., hinge open vs. hinge closed). For example, the XR eyeglasses may have a plurality of hinges where state transitions may depend on hinge positions of the plurality of hinges. In one example, the XR system may be in a deep power state when all hinges of the plurality of hinges are closed. For example, each arm closure may transition the XR system to a low power mode.

In one example, each hinge associated with a plurality of functionalities may be mapped to a user desired configuration. In one example, a plurality of open/close states for the plurality of hinges may define state transitions in the control framework. In one example, state transition to a plurality of low power states may be based on a plurality of hysteresis timers and counters.

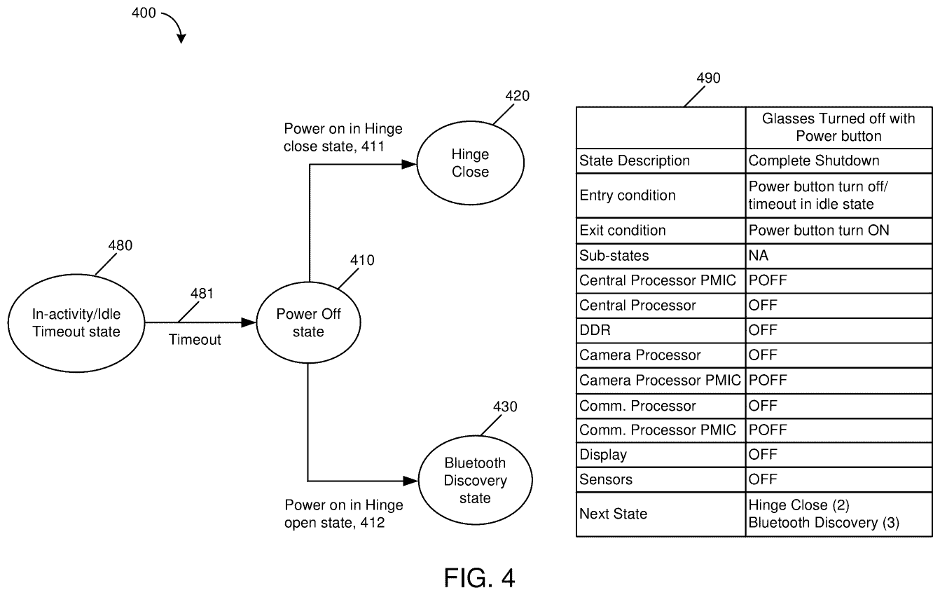

FIG. 4 illustrates an example power off state diagram 400 for an extended reality (XR) system. In one example, the power off state diagram 400 includes a power off state 410 (e.g., the first state 310 of FIG. 3), a hinge close state 420 (e.g., the second state 320 of FIG. 3) and a wireless discovery state 430 (e.g., the third state 330 of FIG. 3). In one example, a power turn on (e.g., a power button activation) causes a transition from the power off state 410 to a first new state. For example, if the power turn on occurs with a hinge closed, a power on in hinge close state transition 411 results in the first new state as the hinge close state 420. For example, if the power turn on occurs with the hinge open, a power on in hinge open state transition 412 results in the first new state as the wireless discovery state 430. In addition, if a timeout 481 occurs while in an idle state 480 (e.g., the eighth state 380 of FIG. 3), a transition to the power off state 410 occurs. In one example, first state description table 490 for the power off state 410 is also shown in FIG. 4.

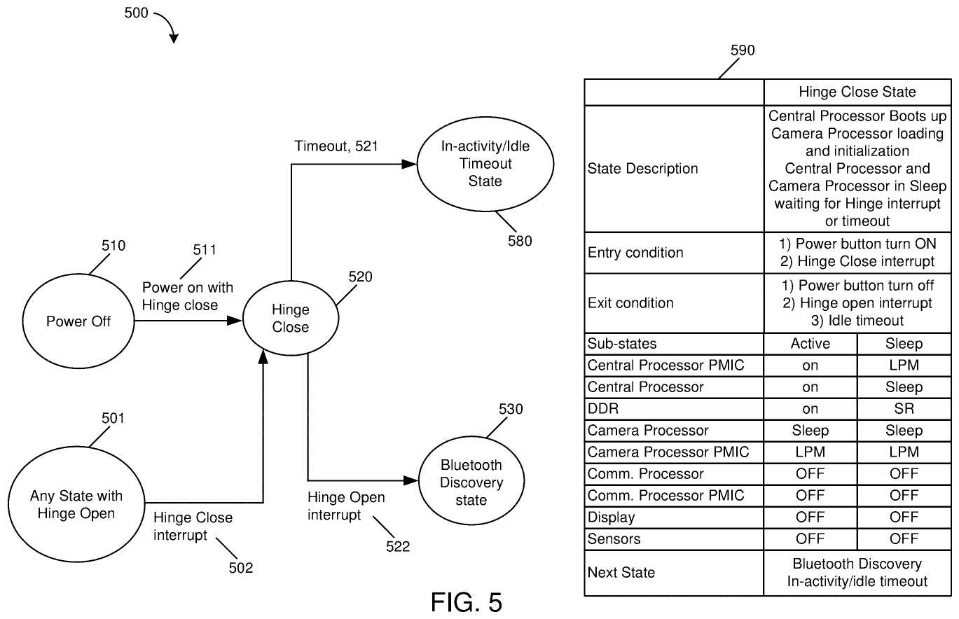

FIG. 5 illustrates an example hinge close state diagram 500 for an extended reality (XR) system. In one example, the hinge close state diagram 500 includes a hinge close state 520 (e.g., the second state 320 of FIG. 3), a wireless discovery state 530 (e.g., the third state 330 of FIG. 3) and an idle state 580 (e.g., the eighth state 380 of FIG. 3). In one example, the XR system starts in a power off state 510 and transitions the XR system to the hinge close state 520 when power is applied and the hinge is closed. In one example, when the hinge is opened, a hinge open interrupt signal 522 transitions the XR system to the wireless discovery state 530. In one example, when the XR system is in the hinge close state 520 and exceeds a hinge close timeout threshold, a hinge close timeout interrupt signal 521 transitions the XR system to the idle state 580. In one example, if the hinge is closed, a hinge close interrupt signal 502 transitions the XR system from any state with the hinge open 501 to the hinge close state 520 (e.g., and discards its ongoing operation). In one example, a second state description table 590 for the hinge close state 520 is also shown in FIG. 5.

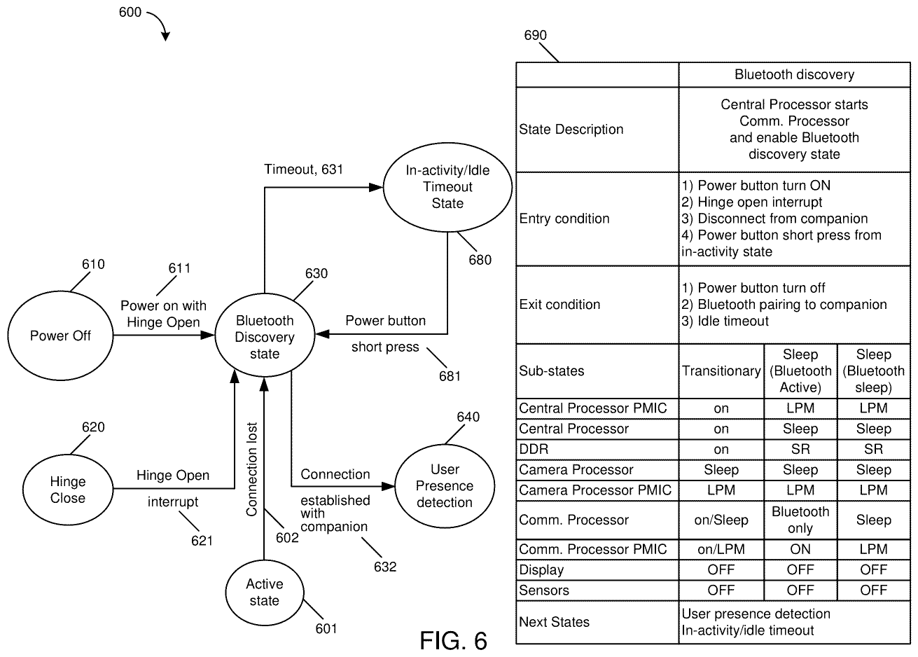

FIG. 6 illustrates an example wireless discovery state diagram 600 for an extended reality (XR) system. In one example, the wireless discovery state diagram 600 includes a wireless discovery state 630 (e.g., the third state 330 of FIG. 3), a user detection state 640 (e.g., the fourth state 340 of FIG. 3) and an idle state 680 (e.g., the eighth state 380 of FIG. 3). In one example, the XR system in the wireless discovery state 630 attempts connection establishment with a wireless companion. In one example, upon receipt of a connection established interrupt signal 632, the XR system transitions to the user detection state 640. In one example, upon receipt of a wireless discovery timeout interrupt signal 631, the XR system transitions to the idle state 680.

In one example, the wireless discovery state 630 may be reached from a power off state 610 (e.g., the first state 310 of FIG. 3) upon reception of a power on with a power on with hinge open interrupt signal 611. In one example, the wireless discovery state 630 may also be reached from a hinge close state 620 (e.g., the second state 320 of FIG. 3) upon reception of a hinge open interrupt signal 621. In one example, if wireless connection is dropped, a connection lost interrupt signal 602 transitions the XR system from any state with the hinge open 601 to the wireless discovery state 630. In one example, a third state description table 690 for the wireless discovery state 630 is also shown in FIG. 6.

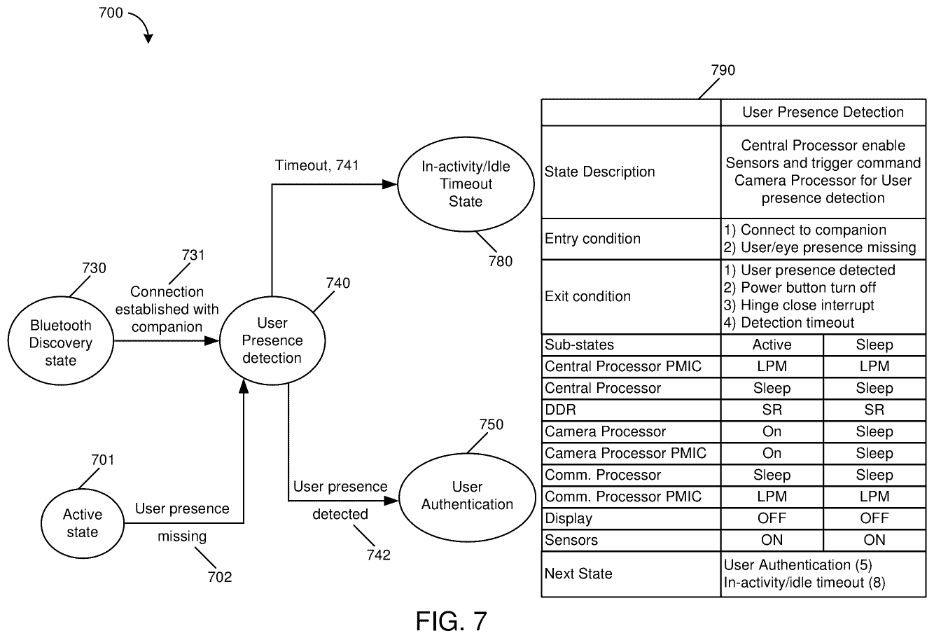

FIG. 7 illustrates an example user detection state diagram 700 for an extended reality (XR) system. In one example, the user detection state diagram 700 includes a user detection state 740 (e.g., the fourth state 340 of FIG. 3), a user authentication state 750 (e.g., the fifth state 350 of FIG. 3) and an idle state 780 (e.g., the eighth state 380 of FIG. 3). In one example, the XR system attempts to detect user presence in the user detection state 740. In one example, when a user is detected, a user detection interrupt signal 742 transitions the XR system to the user authentication state 750. In one example, upon receipt of a user detection timeout interrupt signal 741, the XR system transitions to the idle state 780.

In one example, the user detection state 740 may be reached from a wireless discovery state 730 (e.g., the third state in FIG. 3) upon receipt of a connection established interrupt signal 731 when connection with a wireless companion is established. In one example, a fourth state description table 790 for the user detection state 740 is also shown in FIG. 7.

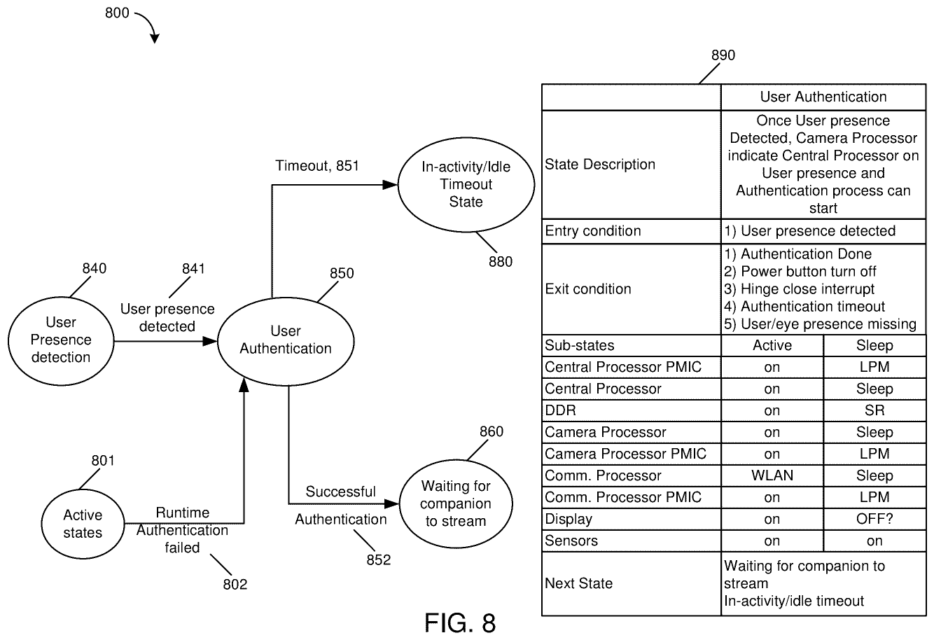

FIG. 8 illustrates an example user authentication state diagram 800 for an extended reality (XR) system. In one example, the user authentication state diagram 800 includes a user authentication state 850 (e.g., the fifth state in FIG. 3), a monitor state 860 (e.g., the sixth state in FIG. 3) and an idle state 880 (e.g., the eighth state in FIG. 3). In one example, the XR system attempts to authenticate a user in the user authentication state 850. In one example, upon receipt of a successful authentication interrupt signal 852, the XR system transitions to the monitor state 860. In one example, upon receipt of a user authentication timeout interrupt signal 851, the XR system transitions to the idle state 880.

In one example, the user authentication state 850 may be reached from a user detection state 840 (e.g., the fourth state in FIG. 3) upon receipt of a user detection interrupt signal 841 when a user is detected. In one example, the user authentication state 850 may also be reached if a runtime authentication failed interrupt signal 802 is received from a pending state 801 (e.g., a monitor state or a user detection state). In one example, a fifth state description table 890 for the user authentication state 850 is also shown in FIG. 8.

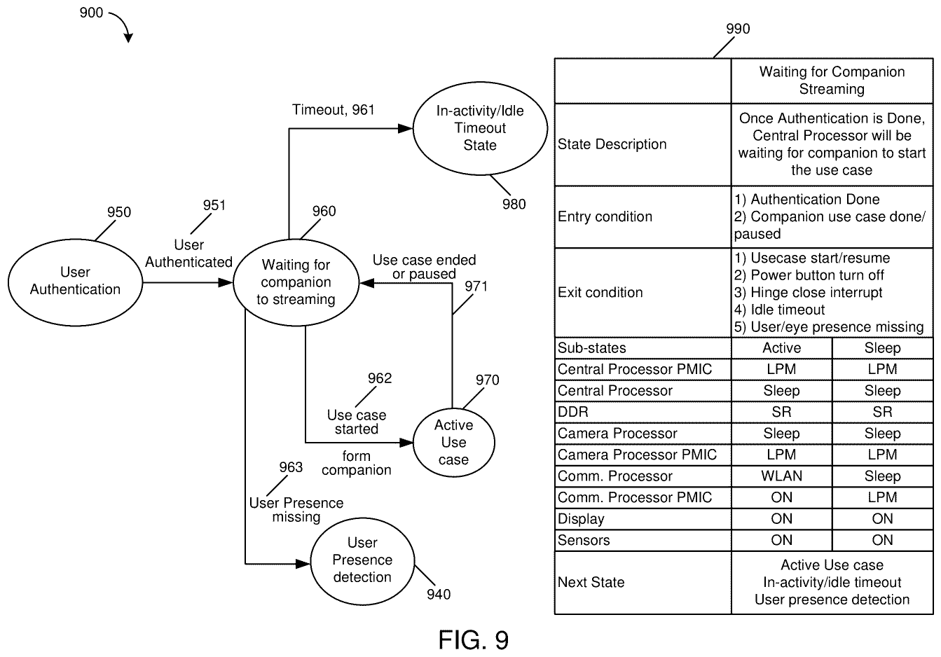

FIG. 9 illustrates an example monitoring state diagram 900 for an extended reality (XR) system. In one example, the monitoring state diagram 900 includes a monitor state 960 (e.g., the sixth state in FIG. 3), a user detection state 940 (e.g., the fourth state in FIG. 3), an active state 970 and an idle state 980 (e.g., the eighth state in FIG. 3). In one example, the XR system waits for a wireless companion to send a data stream while in the monitor state 960. In one example, the XR system transitions to the active state 970 upon receipt of a use case start interrupt signal 962 from the wireless companion.

In one example, the XR system returns to the monitor state 960 from the active state 970 upon receipt of a use case end/pause interrupt signal 971. In one example, the XR system transitions to the user detection state 940 upon receipt of a user missing interrupt signal 963. In one example, the XR system transitions to the idle state 980 upon receipt of a waiting state timeout interrupt signal 961.

In one example, the monitor state 960 may be reached from a user authentication state 950 upon receipt of a user authenticated interrupt signal 951. In one example, a sixth state description table 990 for the monitor state 960 is also shown in FIG. 9.

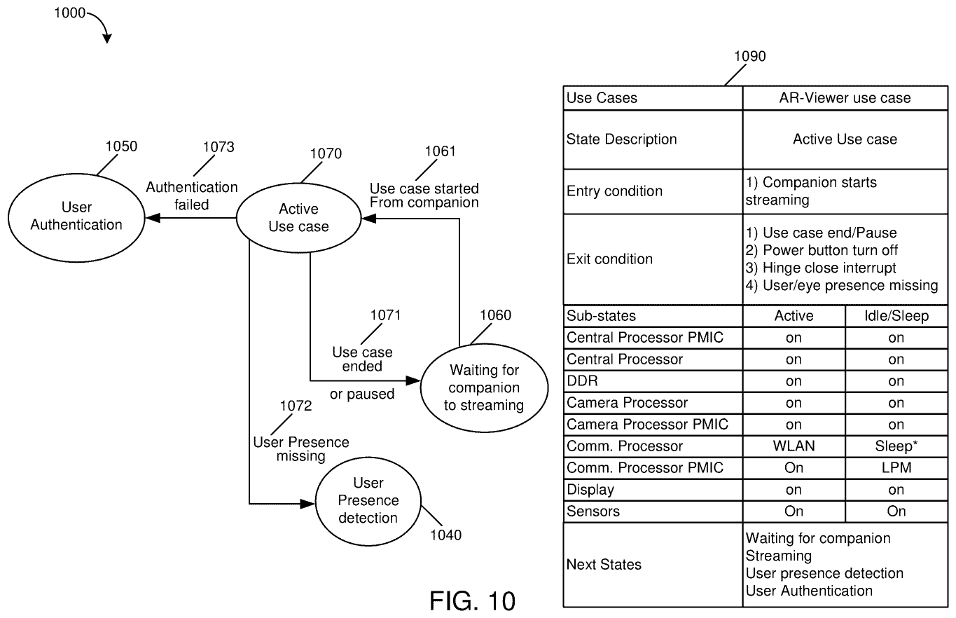

FIG. 10 illustrates an example active state diagram 1000 for an extended reality (XR) system. In one example, the active state diagram 1000 includes an active state 1070 (e.g., the seventh state in FIG. 3), a user detection state 1040 (e.g., the fourth state in FIG. 3) and a monitor state 1060 (e.g., the sixth state in FIG. 3). In one example, the XR system is in the active state 1070 while decoding and managing data frames received from a wireless companion. In one example, the XR system transitions to the monitor state 1060 upon receipt of a use case end/pause interrupt signal 1071. In one example, the XR system returns to the active state 1070 from the monitor state 1060 upon receipt of a use case start interrupt signal 1061. In one example, the XR system transitions to the user detection state 1040 upon receipt of a user missing interrupt signal 1072.

In one example, the active state 1070 may transition to a user authentication state 1050 upon receipt of an authentication failure interrupt signal 1073 when user authentication fails. In one example, the XR system transitions to an idle state 1080 (not shown) upon receipt of an active state timeout interrupt signal 1074 (not shown). In one example, a seventh state description table 1090 for the active state 1070 is also shown in FIG. 10.

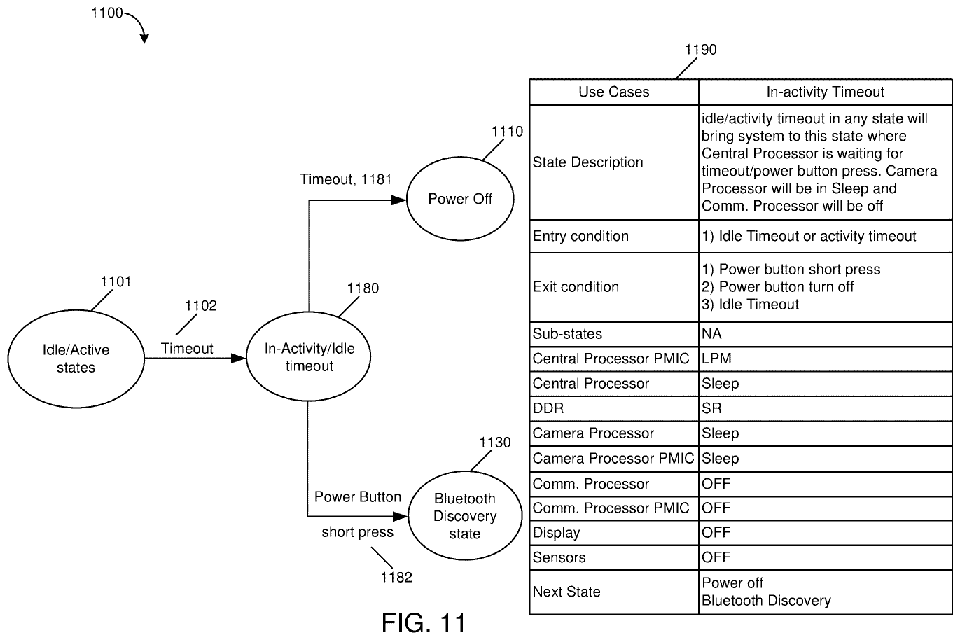

FIG. 11 illustrates an example idle state diagram 1100 for an extended reality (XR) system. In one example, the idle state diagram 1100 includes an idle state 1180 (e.g., the eighth state in FIG. 3), a power off state 1110 (e.g., the first state in FIG. 3) and a wireless discovery state 1130 (e.g., the third state in FIG. 3). In one example, the XR system enters the idle state 1180 from any other state 1101 when a timeout interrupt signal 1102 is received. In one example, the XR system transitions to the power off state 1110 upon receipt of an idle timeout interrupt signal 1181. In one example, the XR system transitions to the wireless discovery state 1130 upon receipt of a power button short press interrupt signal 1182. In one example, an eighth state description table 1190 for the idle state 1180 is also shown FIG. 11.

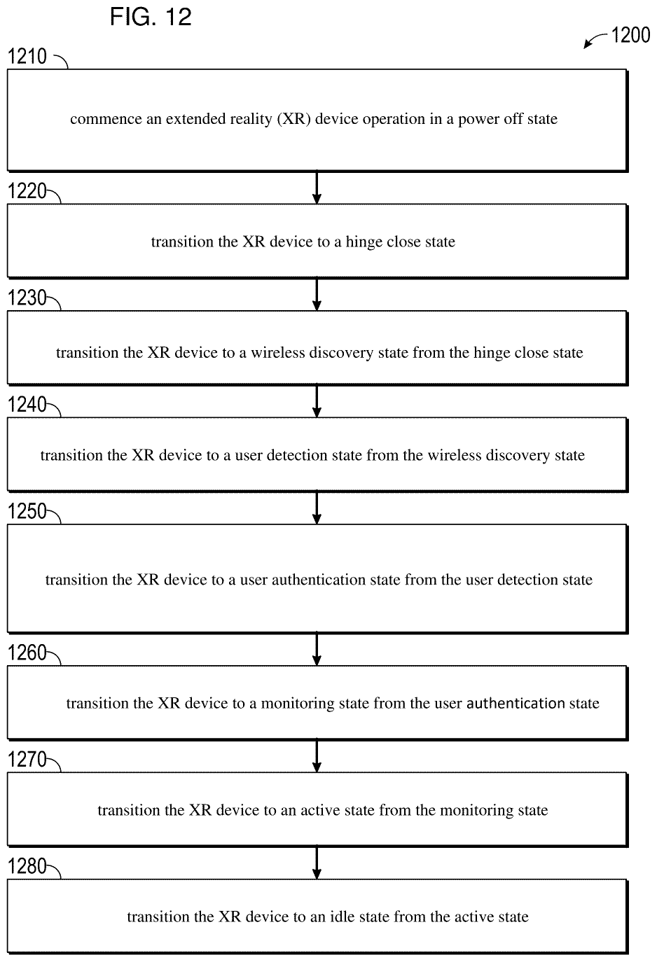

FIG. 12 illustrates an example flow diagram 1200 for an extended reality (XR) device control framework execution. In block 1210, commence an extended reality (XR) device operation in a power off state. In one example, an extended reality (XR) device operation commences from a power off state. In one example, the power off state may be triggered by a timeout interrupt signal. In one example, the step of block 1210 may be performed by one or more of the following separately or in combination: a processor, a microprocessor, a processing engine, a central processor (e.g., central processor 220) and a non-transitory memory, etc.

In block 1220, transition the XR device to a hinge close state. In one example, the XR device is transitioned to a hinge close state. In one example, the hinge close state may be entered upon detection of a closure of at least one hinge of the XR device. In one example, detection of hinge closure may be performed by a hinge sensor. In one example, the hinge close state may be entered from the power off state. In one example, the hinge close state may be entered from any state with at least one hinge close. In one example, the hinge close state may be exited if it exceeds a hinge close timeout threshold and may transition to an idle state. In one example, the step of block 1220 may be performed by one or more of the following separately or in combination: a processor, a microprocessor, a processing engine, a central processor (e.g., central processor 220) and a non-transitory memory, etc.

In block 1230, transition the XR device to a wireless discovery state from the hinge close state. In one example, the XR device is transitioned to a wireless discovery state from the hinge close state. In one example, the wireless discovery state may be entered from the power off state upon detection of an open hinge. In one example, the wireless discovery state may be entered from another state if a wireless connection is lost. In one example, the wireless discovery state attempts to establish a wireless connection with a wireless companion. For example, the wireless companion is a separate device from the XR device. In one example, the wireless connection may employ a Bluetooth link. In one example, the wireless connection may employ a WiFi link. In one example, the step of block 1230 may be performed by one or more of the following separately or in combination: a processor, a microprocessor, a processing engine, a central processor (e.g., central processor 220), a communications processor (e.g., communications processor 230) and a non-transitory memory, etc.

In block 1240, transition the XR device to a user detection state from the wireless discovery state. In one example, the XR device is transitioned to a user detection state from the wireless discovery state. In one example, the user detection state is entered upon establishment of a wireless connection with a wireless companion. In one example, the user detection state attempts to detect a user presence, for example, by monitoring a signal to indicate the user presence. In one example, the user detection state may be entered from any state with detection of a missing user presence. In one example, the step of block 1240 may be performed by one or more of the following separately or in combination: a processor, a microprocessor, a processing engine, a central processor (e.g., central processor 220), a communications processor (e.g., communications processor 230) and a non-transitory memory, etc.

In block 1250, transition the XR device to a user authentication state from the user detection state. In one example, the XR device is transitioned to a user authentication state from the user detection state. In one example, the user authentication state is entered upon detection of a user. In one example, detection of the user may be performed by a plurality of sensors. In one example, the plurality of sensors may include a proximity sensor, an inertial measurement unit (IMU), eye tracking sensor, etc. In one example, the plurality of sensors is used to detect if a user is wearing an XR device (e.g., XR eyeglasses). In one example, the step of block 1250 may be performed by one or more of the following separately or in combination: a processor, a microprocessor, a processing engine, a central processor (e.g., central processor 220), a camera processor (e.g., camera processor 210), a communications processor (e.g., communications processor 230), a plurality of sensors and a non-transitory memory, etc.

In block 1260, transition the XR device to a monitoring state from the user authentication state. In one example, the XR device is transitioned to a monitoring state from the user authentication state. In one example, the monitoring state waits for a companion device to send a data stream. In one example, if a user presence is missing, the XR device is transitioned to the user detection state. In one example, the step of block 1260 may be performed by one or more of the following separately or in combination: a processor, a microprocessor, a processing engine, a central processor (e.g., central processor 220), a communications processor (e.g., communications processor 230) and a non-transitory memory, etc.

In block 1270, transition the XR device to an active state from the monitoring state. In one example, the XR device is transitioned to an active state from the monitoring state. In one example, the active state decodes and manages data frames received from a wireless companion. In one example, if user authentication fails while in the active state, the XR device is transitioned to the user authentication state. In one example, if a user presence is missing while in the active state, the XR device is transitioned to the user detection state. In one example, if a use case is ended or paused, the XR device is transitioned to the monitoring state. In one example, the step of block 1270 may be performed by one or more of the following separately or in combination: a processor, a microprocessor, a processing engine, a central processor (e.g., central processor 220), a communications processor (e.g., communications processor 230) and a non-transitory memory, etc.

In block 1280, transition the XR device to an idle state from the active state. In one example, the XR device is transitioned to an idle state from the active state. In one example, the idle state is entered if a timeout threshold is reached. In one example, the step of block 1280 may be performed by one or more of the following separately or in combination: a processor, a microprocessor, a processing engine, a central processor (e.g., central processor 220) and a non-transitory memory, etc.

In one aspect, one or more of the steps for providing extended reality (XR) device control framework execution in FIG. 12 may be executed by one or more processors which may include hardware, software, firmware, etc. The one or more processors, for example, may be used to execute software or firmware needed to perform the steps in the flow diagram of FIG. 12. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

1. An apparatus comprising:
a non-transitory memory configured to store data to enable transitioning from one state to another state;
a central processor coupled to the non-transitory memory, the central processor configured to perform the following steps in the order prescribed:
(a) transitioning an extended reality (XR) device to a user detection state from a wireless discovery state;
(b) transitioning the XR device to a user authentication state from the user detection state;
(c) transitioning the XR device to a monitoring state from the user authentication state; and
a communication processor coupled to the non-transitory memory, the communication processor configured to detect a user presence upon receipt of a connection established interrupt signal and to authenticate a user in a user authentication state upon receipt of a successful authentication interrupt signal.

2. The apparatus of claim 1, further comprising a plurality of sensors coupled to the communication processor, wherein the communication processor uses the plurality of sensors configured to detect the user presence.

3. The apparatus of claim 2, wherein the plurality of sensors includes at least one of the following: a proximity sensor, an inertial measurement unit (IMU), or an eye tracking sensor.

4. The apparatus of claim 3, wherein the plurality of sensors is further configured to detect the user presence if a user is wearing the extended reality (XR) device.

5. The apparatus of claim 2, wherein the plurality of sensors is further configured to detect the user presence if a user is wearing an extended reality (XR) device.

6. The apparatus of claim 2, wherein the central processor is further configured to transition the XR device to an active state from the monitoring state.

7. The apparatus of claim 6, wherein the communication processor is further configured to:
a) receive one or more data frames from a wireless companion; and
b) decode the one or more data frames.

8. The apparatus of claim 1, wherein the central processor is further configured to transition the XR device to the user detection state after establishing a wireless connection with a wireless companion.

9. The apparatus of claim 8, wherein the wireless connection employs either a Bluetooth link or a WiFi link.

10. The apparatus of claim 6, wherein if an authentication failure is detected in the active state, the central processor is then further configured to transition the XR device to the user authentication state.

11. A method comprising:
enabling a first processor coupled to a non-transitory memory configured to store data to enable transitioning from one state to another state, wherein the processor performs the following steps in the order prescribed:
(a) transitioning an extended reality (XR) device to a user detection state from a wireless discovery state;
(b) transitioning the XR device to a user authentication state from the user detection state;
(c) transitioning the XR device to a monitoring state from the user authentication state; and
enabling a second processor coupled to the first processor, the second processor configured to detect a user presence in the wireless discovery state upon receipt of a connection established interrupt signal and to authenticate a user in a user authentication state upon receipt of a successful authentication interrupt signal.

12. The method of claim 11, further comprising configuring the processor to transition the XR device to an active state from the monitoring state.

13. The method of claim 12, further comprising configuring the processor to transition the XR device to the wireless discovery state from a hinge close state.

14. The method of claim 12, further comprising configuring the processor to transition the XR device to the wireless discovery state upon detection of an open hinge.

15. The method of claim 13, further comprising configuring the processor to transition the XR device to the hinge close state.

16. The method of claim 15, further comprising commencing an XR device operation in a power off state.

17. The method of claim 16, further comprising configuring the processor to transition the XR device to an idle state from the active state.

18. An apparatus comprising:
means for transitioning an extended reality (XR) device to a user detection state from a wireless discovery state;
means for transitioning the XR device to a user authentication state from the user detection state;
means for transitioning the XR device to a monitoring state from the user authentication state; and
means for detecting a user presence in the wireless discovery state upon receipt of a connection established interrupt signal and to authenticate a user in a user authentication state upon receipt of a successful authentication interrupt signal.

19. The apparatus of claim 18, further comprising:
means for transitioning the XR device to an active state from the monitoring state; and
means for transitioning the XR device to the wireless discovery state from a hinge close state.

20. The apparatus of claim 19, further comprising:
means for transitioning the XR device to an active state from the monitoring state; and
means for transitioning the XR device to the hinge close state.
